(19) United States
(12) Patent Application Publication
(10) Pub. No.: US 2013/0008361 A1
(43) Pub. Date: Jan. 10, 2013

(54) LIQUID FERTILIZER SENSOR SYSTEM

(75) Inventors: Ramiro Trevino, Indianola, NE (US); Matthew O'Donnell, Snohomish, WA (US); Brian O'Donnell, Seattle, WA (US)

(73) Assignee: Schaffert Manufacturing Company, Inc., Indianola, NE (US)

(21) Appl. No.: 13/365,015

(22) Filed: Feb. 2, 2012

Related U.S. Application Data
(60) Provisional application No. 61/439,249, filed on Feb. 3, 2011.
(60) Provisional application No. 61/569,199, filed on Dec. 9, 2011.

(51) Int. Cl. A01C 23/02; F17D 3/00; F16K 37/00

(52) U.S. Cl. 111/120; 137/551; 137/565.01

(57) ABSTRACT

A system for fertilizing a large area. The system may include a fluid bar configured to be towed by a tractor. The fluid bar may include a fluid passageway with at least one aperture and a sensor or meter in communication with the aperture. The aperture may be configured to receive a hose or other attachment distributing fluid to the ground. The system may include a tank, a pump, pump controller and a filter. The pump flow rate and the outlet flow rate may be displayed on monitoring equipment located within a cab of the tractor. The pump controller may be used by the farmer to variably adjust the fluid pressure in each aperture and consequently adjust the flow pressure of fertilizer added to the ground.

### CROSS-REFERENCE TO RELATED APPLICATIONS

This application claims the benefit, under 35 U.S.C. §119(e), of U.S. provisional application No. 61/439,249, entitled “Liquid Fertilizer Sensor System” and filed on Feb. 3, 2011; and U.S. provisional application No. 61/569,199, entitled “Intelligent Pump System” and filed on Dec. 9, 2011. These applications are hereby incorporated herein by reference in their entireties.

### TECHNICAL FIELD

The technical field relates generally to agricultural planting equipment, and more specifically to fertilization and monitoring systems for planting equipment.

### BACKGROUND

Mechanical seed planting devices are used to plant seeds in large areas, for example farms having over an acre. Planting devices are often pulled by a tractor and may include multiple planting units. Each planting unit holds seeds and may include a device to create a furrow in the ground as the tractor moves forward. When the furrow is created, a seed is deposited into the ground via a seed dispensing apparatus. Farmers often want to fertilizer the seed within the furrow at the time the seed is deposited. In these cases, the planting machine may include a fertilizer unit along with the planting unit. The fertilizer unit deposits fertilizer in the furrow along with the seed as the tractor moves. Problems arise if too much or too little fertilizer is included along with the seed. Too much fertilizer and the seed may die, grow too rapidly or otherwise be unhealthy. Similarly, too little fertilizer and the seed may not germinate. Current fertilizer systems do not accurately monitor the fertilizer dispensed into each furrow or allow for easy adjustment of the fertilizer levels deposited, and current systems may not detect whether liquid is flowing at all. Further, existing fertilizer systems may rely on the pump performance to regulate and control fertilizer flow, which may not always be an accurate measure.

### SUMMARY

Some embodiments of a fertilizer apparatus may include a fluid bar configured to be towed by a tractor or other vehicle. The fluid bar may be fluidly connected to a fertilizer source. The fluid bar may contain a fluid passageway in fluid communication with apertures for dispensing the fertilizer. There may be sensors for monitoring the fluid flow through the apertures. The sensor information may be utilized to determine a fluid flow rate through the apertures. The apparatus may also include a sensor monitor that displays the flow rate as detected by the sensors. The apparatus may further include a pump that is configured to pump fertilizer from the fertilizer source to the passageway. Additionally, the system may include a pump controller to adjust the pump flow rate.

Some embodiments of a liquid fertilizer dispensing system may include a tractor, a fertilizer bar configured to be attached to the tractor, and monitoring equipment. The fertilizer bar may include a fluid passageway, at least one outlet for the passageway, a sensor for each outlet, a tank for storing fertilizer or other liquids, and a pump for pumping the fertilizer or liquid from the tank to the fluid passageway. The monitoring equipment may include a sensor monitor to display the flow rate of the fertilizer or liquid through the outlet as measured by the sensors. There may be multiple outlets, and each outlet may include a sensor. Additionally, the system may include a pump controller for adjusting the pump rate of the pump. The monitoring display and the pump controller may be located within a cab of the tractor.

Some embodiments of a liquid flow metering system may include a reservoir, a pump, multiple fluid outlets, multiple sensors, a hardware control, and a software control unit. The reservoir may be configured to store a liquid. The pump may be in fluid communication with the fertilizer reservoir and the multiple fluid outlets. The multiple fluid outlet may be configured to deliver to a desired area liquid received from the reservoir via the pump. The multiple sensors may be configured to monitor a flow rate of the liquid to each of the multiple fluid outlets. Each of the multiple sensors may be operatively associated with the hardware control. The hardware control may be operatively associated with a software control unit.

### BRIEF DESCRIPTION OF THE DRAWINGS

Exemplary embodiments are illustrated in referenced figures of the drawings. It is intended that the embodiments and figures described herein are illustrative rather than limiting. The use of the same reference numerals in different embodiments indicates similar or identical items.

FIG. 1 is a perspective view of a tractor joined to a planting bar and a fertilizer system

FIG. 2 is a block diagram of the fertilizer system, as illustrated in FIG. 1.

FIG. 3 is an enlarged view of a fertilizer bar for use with the fertilizer system.

FIG. 4 is another embodiment of the fertilizer bar including a set of seed covers attached thereto.

FIG. 5 is an embodiment of the fluid bar illustrating another embodiment of the sensor monitor.

FIG. 6 shows a schematic view of a system for monitoring the application of liquid fertilizer onto an agricultural field.

FIG. 7 shows a schematic illustration of a possible architecture and design for providing information to a hosted software solution

FIG. 8 shows a possible navigation map for a user interface of a software control unit.

FIG. 9 shows a potential loading screen for the user interface.

FIG. 10 shows a potential dashboard screen for the user interface.

FIG. 11 shows a potential meters screen for the user interface.

FIG. 12 shows a potential meter details screen for the user interface.

FIG. 13 shows a potential settings screen for the user interface.

FIG. 14 shows a potential setting screen for the user interface.

FIG. 15 shows a potential database configuration for the software control module.

### DETAILED DESCRIPTION

Although one or more of the embodiments of a planting system may be described herein in detail with reference to a particular fertilizer system, the embodiments should not be interpreted or otherwise used as limiting the scope of the claims. In addition, one skilled in the art will understand that the following description has broad application. For example, while embodiments of various systems described herein may focus on fertilization of furrows, the concepts described herein equally apply to other fertilization and planting techniques, or other ways of placing liquids (such as herbicides, insecticides, or other liquids beneficial to support and enhance crop growth) on seeds, plants, or fields. Additionally, the concepts described herein may equally apply to other forms of nutrient or liquid deposit, such as watering. Furthermore, while embodiments of various systems described herein may focus on a fertilization bar, the concepts described herein equally apply to other types of mechanical fertilization equipment. For example, in some embodiments, the fertilizer system may be integral with a tractor or may be used without a tractor. Accordingly, the discussion of any embodiment is meant only to be exemplary and is not intended to suggest that the scope of the claims is limited to these embodiments.

In some embodiments, the fertilization system includes a fertilizer bar pulled by a tractor. The fertilizer bar may include multiple mounts having apertures or outlets providing a connection to hoses. Each mount may include a flow sensor. The fertilizer bar may be fluidly connected to a pump and set of filters. The may be used to transfer fertilizer from a tank to the fertilizer bar. Additionally, the fertilizer bar may include an electrical connection to one or more of a sensor monitor, a pump rate controller, and a pressure gauge. The sensor monitor, the pump rate controller and the pressure gauge may be installed within the cab of a tractor. In this implementation, the farmer may monitor from the cab each mount aperture, and consequently each hose, to confirm that the correct amount of fertilizer is deposited into each furrow and to adjust the fertilizer levels if necessary.

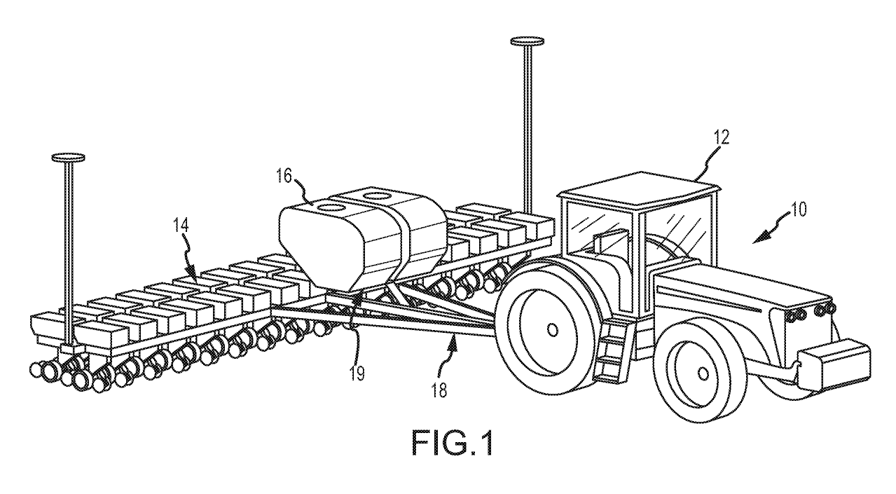

In some embodiments, the fertilizer system may be implemented within a tractor setup and include a fertilizer bar that may be pulled behind a tractor. FIG. 1 shows a schematic illustration of a tractor 10 pulling a fertilizer bar 14. The tractor 10 may be any type of tractor or other device capable of towing a bar. The tractor 10 may include a cab 12 for the farmer to sit. The cab 12 may include driving equipment, such as a steering wheel, shifter, etc., as well as other monitoring equipment, such as gas usage, speed, global positioning system, etc. The tractor 10 may connect to the fertilizer bar 14 via a hitch bar 18. The hitch bar 18 may be integrated with the fertilizer bar 14, integrated with the tractor 10, or separate from both the tractor 10 and fertilizer bar 14. The hitch bar 18, in addition to towing the fertilizer bar 14, also provides a pathway for connection wires to run between the fertilizer bar 14 and the cab 12.

The fertilizer bar 14 may include a platform 19 for supporting a tank 16, pump equipment (not shown) and other components. The platform 19 may be integrated with the fertilizer bar 14, the hitch bar 18 or both. The fertilizer bar 14 may include planting equipment, in addition to the fertilizing equipment. For example, the fertilizer bar 14 may include a fluid bar having apertures for the fertilizer to be distributed, as well as a device for creating furrows (e.g., a disc opener) and a seed distributor for placing the seeds within the furrow. However, the fertilizer bar 14 may be separate from the planting equipment or integrated within a single bar. The fertilizer bar 14 may additionally be part of the tractor 10. For example, the bar 14 may be an integrated accessory for the tractor 10.

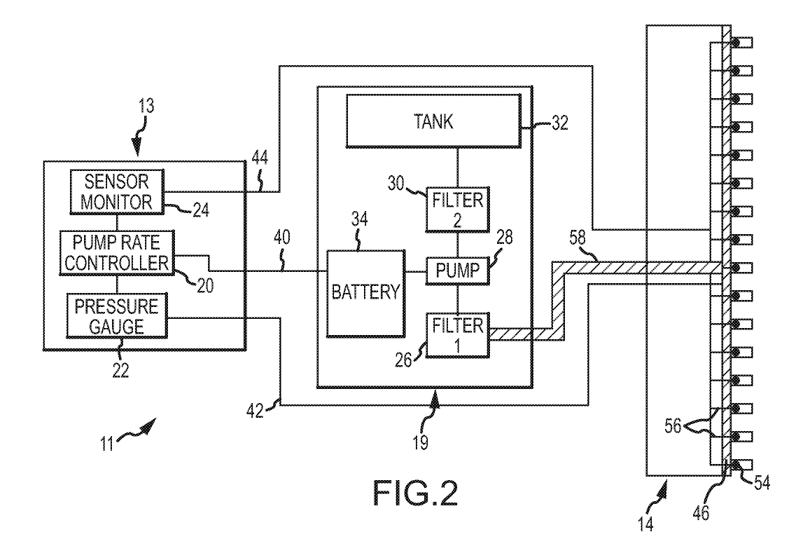

The fertilizer system for monitoring the amount of fertilizer distributed into each furrow may be implemented in combination with the fertilizer bar 14 and the tractor 10. FIG. 2 illustrates a block diagram view of some embodiments of the fertilizer system 11. The fertilizer system 11 may include monitoring and adjusting equipment 13. This monitoring and adjusting equipment 13 may be located within the cab 12 of the tractor 10. This arrangement allows the farmer to monitor and adjust the fertilizer system 11 while operating the tractor 10. The monitoring and adjusting equipment 13 may be electrically connected to components hosted on the platform 19 as well as components hosted on the fertilizer bar 14. The platform 19 may further include a fluid connection between the components hosted on the platform 19 and the fertilizer bar 14.

The platform 19 may support the tank 16, a first filter 26, a pump 28, a second filter 30, and a battery 34. The tank 16 may be fluidly connected through a hose or other suitable fluid connection member or system to the first and second filters 26, 30 and the pump 28. The tank 16 may hold liquid fertilizer, water, or any other desired materials for depositing within a furrow. The first and second filters 26, 30 may filter the fertilizer or other materials deposited into the furrow. The first filter 26 may receive liquid from the pump 28 and then deliver the fertilizer to the fertilizer bar 14 via a fluid conduit 58. The fluid conduit 58 may be any type of connection able to transmit fluid, such as a hose, a pipe, or the like. The second filter 30 may receive the fertilizer from the tank 32 and distribute it to the pump 28. The filters 26, 30 may be any type of filter, for example, a simple screen to remove large particles from the fertilizer or a more complex chemical filter for removing unwanted chemical compounds. One or more filters may be used to help keep the orifices from becoming plugged. Although two filters are illustrated in FIG. 2, there many be any number of filters included within the fertilizer system 11. Additionally, if no filtering is desired, the filters 26, 30 may be omitted.

The pump 28 may be located between the first filter 26 and the second filter 30. The pump 28 pulls fertilizer from the tank 32 and delivers the pulled fertilizer to the fertilizer bar 14. In some embodiments, the pump 28 may pump between a range of 0-40 gallons per minute. However, the pump 28 may be designed to pump at any desired level, for example, faster or slower than 30 gallons per minute. The pump 28 may be an electric pump and may include a diaphragm to control the fertilizer flow through the pump 28. The pump 28 may also include rollers that press the diaphragm in order to move the fertilizer through the pump 28. The pump 28 may be any other type of pump, including, but not limited to, a centrifugal pump, plunger pump, and so on. In addition to being connected to the filters 26, 30, the pump 28 may also be connected to the battery 34. In some embodiments, the battery 34 supplies power to the pump 28. For example, if the pump 28 is an electric pump, the battery 34 supplies the electricity required to operate the rollers or other electrical components. The battery 34 may be any type of battery, such as a 12 Volt alkaline battery, a rechargeable battery, and so on. The battery 34 may also be omitted. For example, the pump 28 may be wired to receive power from the tractor 10 engine or another power source. The battery 34 and the pump 28 may additionally be connected to the monitoring and adjusting equipment 13. In this implementation, the battery power level as well as the pump rate may be monitored by the farmer from within the cab 12.

The monitoring and adjusting equipment 13 may include a sensor monitor 24, a pump rate controller 20, and a pressure gauge 22. The pump rate controller 20 is electrically connected to the battery 34 and the pump 28. The pump rate controller 20 may be connected to the battery 34 via a controller wire 40. The pump rate controller 20 may be utilized to adjust the pump rate of the pump 28. The pump rate controller 20 may include a display or other user interface to allow an operator of the tractor 10 to adjust the pump 28 from the cab 12. The display or interface (not shown) may include an analog or digital display to illustrate the current rate of the pump flow and a knob, one or more button, a touch screen or other control mechanism to allow the operator to change the pump flow rate. In some embodiments, the adjustment control mechanism may provide the operator a predetermined number of options for the pump flow rate, such as low, medium and high speed. The display or interface feature allows the operator of the tractor to adjust the amount of fertilizer deposited in the furrows from the convenience of the cab 12. This also allows the operator to adjust the fertilizer output while the system is operating without having to stop the tractor 10. The pump controller 20 may be any device that can control the pump rate of a pump. For example, if the pump 28 is an electrical pump, the pump controller 20 may be an electrical dial connected to the rollers and/or diaphragm to alter the speed of the rollers in response to the operator's selected input.

The pressure gauge 22 may be electrically connected to the pump rate controller 20. The pressure gauge 22 measures the pressure of fertilizer distributed by the fertilizer bar 14. Similar to the pump rate controller 20, the pressure gauge 22 may include a user display and/or interface. The user display and/or interface (not shown) illustrates to the tractor operator the current pressure and may be shown using a numerical output, a needle indicator, etc. This feature provides the tractor operator with a current reading of output pressure in order to better determine the amount of adjustment (if any) necessary for the pump 28. Also, the pressure gauge 22 may alert the farmer if the pump 22 or other components are malfunctioning. For example, if the pressure gauge 22 displays a low pressure the tractor operator may then inspect the pump 28 for a potential problem.

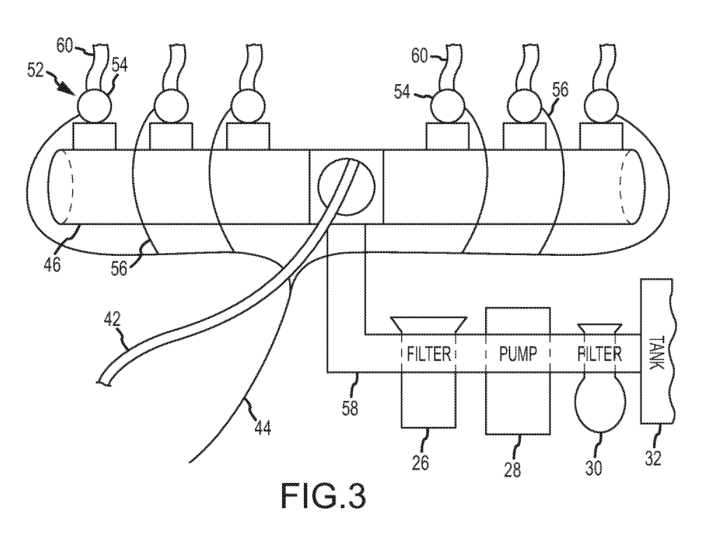

Referring now to FIGS. 2 and 3, the sensor monitor 24 may be electrically connected to a fluid bar 46 attached to the fertilizer bar 14. Specifically, the sensor monitor 24 may be electrically connected to sensors 54, meters, or the like located at mount apertures along the fluid bar 46. The sensors 54 measure the rate of fertilizer flowing (including the absence of flow) through each aperture, and the sensor monitor 24 displays the results. The sensors 54 may be any suitable sensor for measuring the flow rate of a fluid, such as a flow nozzle, velocity flow meter, venturi tube, etc. In some embodiments, the sensors 54 may also measure the pressure of the fluid. For example, the sensors 54 may be placed within the mount aperture and as such determine the pressure exiting the outlet of the mount aperture as well as the pressure of the fertilizer as it enters the hose 60 attached to the end of the mount 52.

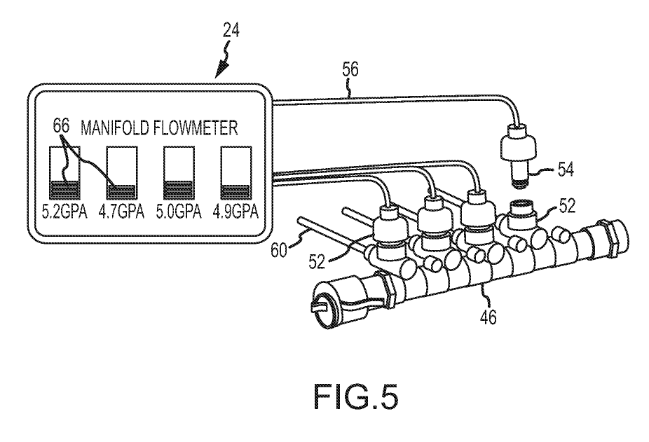

FIG. 5 illustrates another embodiment of the fluid bar 46 and sensor monitor 24. Referring now to FIGS. 2,3 and 5, the sensor monitor 24 may include a user display 66 located in the cab 12 of the tractor 10. The display 66 indicates to the tractor operator the amount of fertilizer being discharged by the system 11. In these embodiments, the sensor monitor 24 may be directly connected to each mount 52 and each sensor 54. This allows the sensor monitor 24 to include a display 66 for each mount aperture and each mount 52. The display 66 may include a reading of the flow rate registered by each sensor 54. For example, the display 66 may have a digital number output, a dial, a graphical display, etc. The reading may display gallons per minute, gallons per acre, liters per minute, etc.

These embodiments allow for the tractor operator to determine the type of adjustments that may be necessary to the pump 28. For example, if too much fertilizer is being discharged from the system 11, the tractor operator may be worried about harming the seeds and may subsequently adjust the pump 28 via the pump controller 20 to lower the flow rate. Additionally, the sensors 54 may indicate to the tractor operator whether the system is operating properly. For example, if one of the mount apertures is blocked or clogged, the sensor 54 will measure a low or zero flow rate. This would alert the tractor operator that there may be a problem with the aperture associated with the sensor 54.

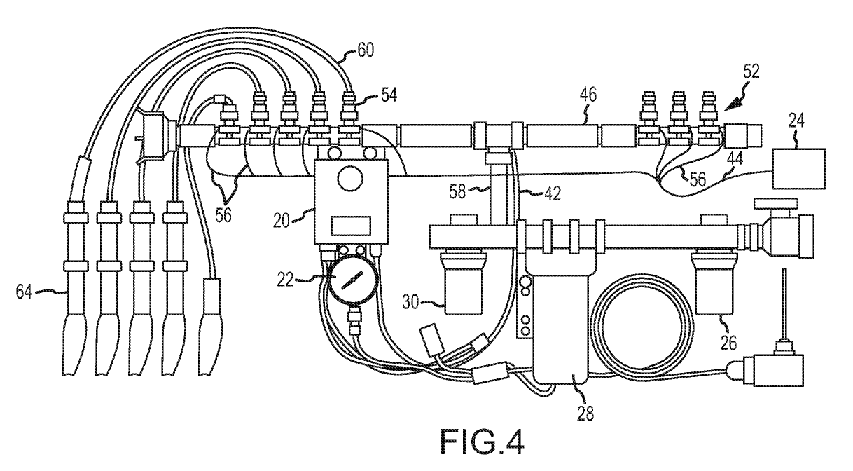

The sensor monitor 24 may be connected to the various sensors 54 through a sensor wire 44, such as shown in FIG. 4, or may be wirelessly connected with the various sensors 54. The sensor wire 44 may extend between the sensor monitor 24 and the sensors 54. The sensor wire 44 may be mounted on the hitch bar 18 and the platform 19. The sensor wire 44 may additionally be formed of individual wires 56 that converge to form a single wire line that is connected to the sensor monitor 24. These individual wires 56 each receive an electronic signal from the sensors 54 and then send such signal back through the sensor wire 44 to the sensor monitor 24. The sensor wire 44 may be a singular electrical bus providing a signal path for each of the individual wires 56, or the sensor wire 44 may be simply the extension and combination of all the individual wires 56. In other embodiments, the sensor wire 44 may be omitted, such that each individual wire 56 directly connects to the sensor monitor 24, as shown in FIG. 5. The connectivity of the system, between components, may be wireless.

Referring again to FIGS. 2 and 3, the pressure gauge 22, in addition to being electrically connected to the pump controller, may also be disposed within the fluid bar 46. The pressure gauge 22 measures the pressure of the fertilizer flowing from the first filter 26 to the fluid bar 46. The pressure gauge 22 may be connected to the fluid bar 46 via a gauge wire 42. The gauge wire 42 may be mounted along the hitch bar 18 and/or the platform 19 on its way from the pressure gauge 22 to the fluid bar 46. The pressure gauge 22 may be located at the outlet of the first filter 26, at the inlet of the fluid bar 46, or may be located at the outlet of the pump 28. The variety of locations allows for the pressure gauge 22 to be positioned to determine the pressure at any desired location within the fluid flow. Additionally, although a singular pressure gauge 22 has been shown, multiple gauges may be used. For example, the tractor operator may wish to know the pressure of the fertilizer leaving the pump 28, and also the fluid pressure as it enters the fluid bar 46. In these cases, two or more pressure gauges 22 may be implemented within the fluid flow to give an accurate reading of fluid pressure at different locations. The pressure gauge 22 may include a sensor (not shown) for measuring the pressure in the fluid bar 46. The sensor may be any device capable of determining pressure changes, for example a spring, hydraulic fluid, etc. The purpose of the pressure gage is to help regulate the flow rate, such as in gallons per acre. By monitoring the pressure gauge, such regulation may be accomplished. The pressure gage may work in concert with the sensor to help regulate the flow of liquid.

FIG. 3 is a enlarged view of one embodiment of the fluid bar 46. The fertilizer bar 14 may include the fluid bar 46. The fluid bar 46 may be cylindrically shaped and hollow or any other desired shape. The fluid bar 46 defines a passageway for fertilizer to flow when transported via the fluid conduit 58 from the first filter 26. The fluid bar 46 in some embodiments is polyvinyl chloride (PVC), however the fluid bar 46 may be any suitable material, such as metal, other types of plastic, etc. Additionally, the fluid bar 46 in some embodiments may take the form of ¾ inch PVC, however in other embodiments the fluid bar 46 may be other sizes or materials, depending on the fertilizer requirements. For example, if the fields to be fertilized require a large amount of fertilizer, the fluid bar 46 may have a larger diameter to accommodate more fluid. The fluid bar 46 may be attached to the fertilizer bar 14, may be attached to a planting tool bar (not shown) or may be a separate device. This attachment feature makes the fluid bar 46 versatile because it may be added to an existing planting or fertilizing bar or may operate on its own. In some embodiments, the fluid bar 46 may be attached to a fertilizer bar 14 provided as part of the tractor 10 assembly. This allows the fertilizer system 11 to be added to tractor operator's existing equipment, which may result in a reduction of expenses.

The fluid bar 46 may include mounts 52, which have apertures (not shown), and may be attached to hoses 60 or other fluid transporting apparatuses. Each mount 52 may be configured to attach and secure a respective hose 60 to the fluid bar 46. Additionally the mounts 52 may be configured to provide for a variety of different attachments. For example, the mounts 52 may be used in conjunction with spray nozzles to spray the fertilizer into the furrow. Similarly, the mounts 52 may be used with a sprayer to spray water above the ground, without depositing the water directly into a furrow. However, depending on the type of hose 60, or other attachment used with the fluid bar 46, the mounts 52 may be omitted. For example, the hose 60 may include another attachment mechanism that allows for attachment directly to the fluid bar 46. In some embodiments, the hose 60 may be ¼ inch tubing, however in other embodiments the hose 60 may be other sizes. The mount apertures may be located at any position on the mounts 52 and additionally may be any diameter. The size and position of the apertures depends on the tractor operator's needs. For example, to increase the amount of fertilizer deposited to the hoses 60, the mount apertures may be larger. On the other hand, if the tractor operator wants to deposit less fertilizer in each furrow, the mount apertures may be smaller.

The pressure gauge wire 42 may be located within the fluid bar 46, such that the pressure gauge wire 42 may measure the pressure of the fertilizer flowing through the passageway. As discussed above, the pressure gauge 22 may include a sensor or other device for measuring the pressure within the fluid bar 46. As such, the pressure gauge wire 42 may include the sensor and may transport the readings from the fluid bar 46 to the gauge, or the pressure gauge 22 may be located on the end of the pressure gauge wire 42 inserted within the fluid bar 46. In some embodiments, the pressure gauge wire 42 is ¼ inch tubing. However, the pressure gauge wire 42 may be any diameter and be constructed out of any appropriate material for transporting pressure data.

In operation, the fertilizer may travel from the tank 32 through the second filter 30, through the pump 28, through the first filter 26, and through the fluid conduit 58 before reaching the passageway. Once reaching the fluid bar 46 passageway, the fertilizer may exit the fluid bar 46 via the mount apertures. As the mount apertures may be connected to hoses 60, the fertilizer may then enter each hose 60 to be directed to the appropriate location. For example, each hose 60 may be directed to a specific furrow and the fertilizer will be deposited within each furrow.

FIG. 4 illustrates an embodiment of the fluid bar 46 including seed cover assemblies attached to the hoses. Referring now to FIGS. 3 and 4, the hose 60 may be included as part of a seed cover assembly 64. The seed cover assemblies 64 may be used in conjunction with a planting device. In these embodiments, the seed cover assembly 64 directs seeds from the planting device into a furrow. Additionally, the seed cover assembly 64 may also include the hose 60 and may be used to position each hose 60 into a furrow. In this embodiment, the seed and the fertilizer may be deposited at essentially the same time and in the same location within the furrow. This helps to insure that the seed will be able be contacted by the fertilizer, as the fertilizer will be located at the same depth and location as the seed. For example, the hose 60 may be supported by a frame directing the hose into a specific furrow and at a specific angle. Additionally, the hose 60 may include a variety of different nozzles, or end pieces to direct the fertilizer appropriately into the ground. Of course, no seed cover assemblies need be used with this system.

In one embodiment, the system monitors whether or not there is flow, and if there is flow sensed, it may also monitor and or measure what the flow rate is. The system may store in memory, for possible later recall and use, the volume (such as gallons) applied per acre. This data may be used to determine the average volume applied per acre, or may be used to determine where (location) liquid was applied in the acre, when such application data is cross referenced with a GPS (global positioning system) data acquisition that maps the movement of the application system in a given area (such as a farm field).

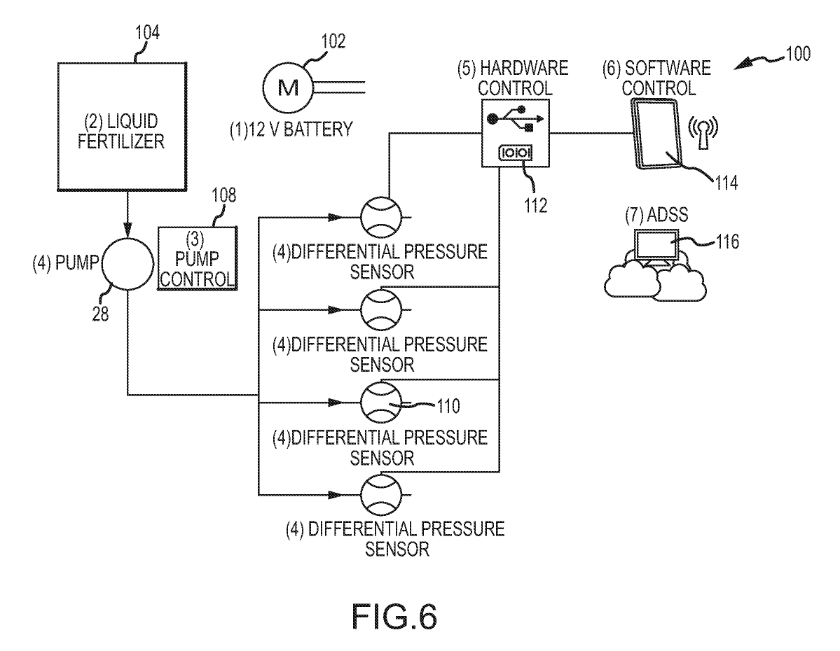

FIG. 6 illustrates a schematic view of a system for monitoring the application of liquid fertilizer onto an agricultural field. The system may be configured to provide automated monitoring of a liquid fertilizer application via electrical sensors. The system may further be configured to monitor one or more of the following situations: the plugging of a liquid fertilizer tube or row unit; when and where the liquid fertilizer tube or row unit was plugged; a demand flow ratio or a flow rate of the liquid fertilizer; and a temperature of the liquid fertilizer. By monitoring such parameters, the system provides a mechanism to help ensure that liquid fertilizer is properly applied during the planting of crops to increase the likelihood that good stands and crop yields are obtained. Further, in some embodiments, the system may be further configured to capture this information on a hosted solution that allows for the overlay of this data with other information, such as, but not limited to, pH of the soil, rain or other weather events, and market conditions.

With reference to FIG. 6, the system 100 may include a power source 102, a liquid fertilizer or other liquid source 104, a pump 28, a pump control 108, one or more pressure sensors 110, a hardware control 112, a software control unit 114, and a hosted software solution 116. The power source 102 may be utilized to provide power to one or more of the pump 28, the pump control 108, the hardware control 112, and the software control unit 114. The power source 102 may be a 12 volt battery or any other suitable electrical power supply. As described in more detail above, the pump 28 may be fluidly connected to the liquid source 104 and configured to deliver fluid from the liquid source 104 to the hoses 60 that are in fluid communication with the pump 28. The pump 28 may be controlled using the pump control 108. The pump control 108 provides the ability for an operator to operate the pump 28 to deliver a desired amount of liquid from the liquid source 104 to the hoses 60.

The pressure sensors 110 may be positioned between the pump 28 and the hoses 60. In some embodiments, each pressure sensor 110 may be installed on each row of the fertilizer manifold or fluid bar 46. In such embodiments, each pressure sensor 110 may be configured to measure the differential pressure based on the readings of two absolute sensors. This information may then be utilized to determine the liquid flow rate through a respective hose 60. The pressure sensors 110 may be configured to sample the flow rate up to 50 times per second, or at any other desired sampling rate. This information may be retrieved using a serial port or the like that is connected to the pressure sensors 110. The serial port may be part of the hardware control 112 and may be a RS485 serial port or any other suitable serial port.

The hardware control 112 may be connected to the pressure sensors 110 and to the software control unit 114. The hardware control 112 may take the form of a hardware BUS that interfaces between the pressure sensors 110 and a USB standard output. The hardware control may be powered to strengthen the USB signal to allow the signal to be transferred greater distances.

The software control unit 114 may include one or more of the following modules: management software, an interface layer, processing logic, and a user interface. The management software may contain the management functions that are needed to query the sensors on the BUS and to configure/store the unique BUS address for each sensor. The management software may then be used to query to BUS via an appropriate protocol, such as a RS485 protocol, to retrieve the pressure information. The interface layer may contain the required interface logic to translate between the commands for a mobile operating system and the pressure device internal RS485 protocol. The processing logic module may contain the logic needed to poll the sensor device through the interface on a configurable interval and to store the pressure/flow rate information into an internal database. The processing logic module may further be configured to receive and record other pertinent information, such as the longitude and latitude of a tractor or other farm equipment that is obtained using GPS equipment, identification information for operators of the software or the farm equipment, temperature of the liquid, timestamp information, and other configuration data. The user interface may be configured to display pressure readings obtained from the pressure sensors. In some embodiments, each sensors' measurements may be displayed and alarms may be triggered in the event that the readings from one or more of the sensors falls outside of configurable maximum and minimum readings.

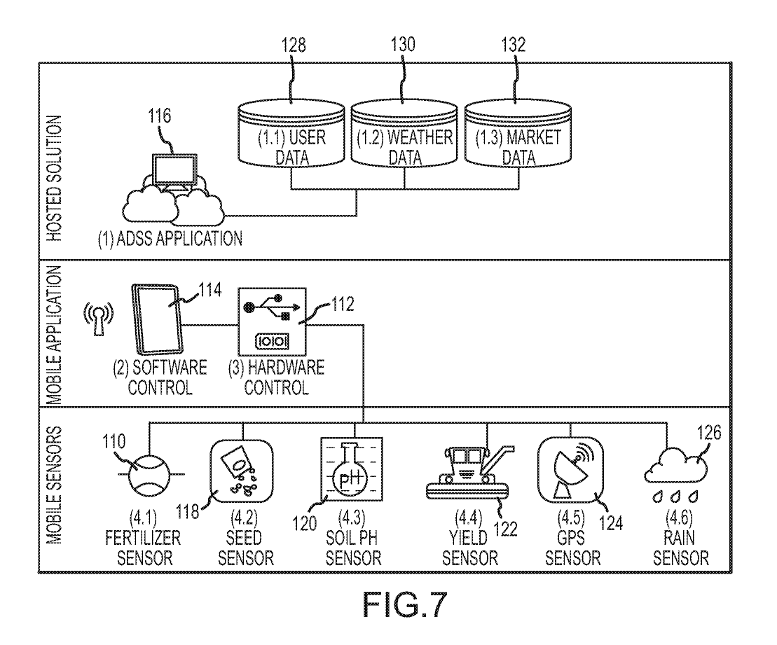

FIG. 7 shows a schematic illustration of a possible architecture and design for providing information to the hosted software solution 116. With reference to FIG. 7, various sensors may be joined to the software control unit via the hardware control. The sensors may include fertilizer flow rate or pressure sensors or meters 110, seed sensors 118, soil pH sensors 120, yield sensors 122, GPS sensors 124, rain sensors 126, and any other sensors that measure desired information. As described in more detail above with respect to the pressure sensors 110, each of these sensors may be joined to the hardware control 112, which may be configured to receive signals or the like from the sensors and transfer these signals to the software control unit 114 for analysis and storage. The software control unit 114, in turn, may be configured to deliver the information received from the sensors via the hardware control 112 to the hosted software solution 116. The information may be delivered wirelessly or may be delivered by connecting the software control unit 114 to hardware containing the hosted software solution 116 via a wire or the like. The hosted software solution 116 may further be configured to receive user data 128, weather data 130, market data 132, and other information of interest from various databases. This data may reside in databases stored on the hardware for the hosted software solution 116 or may be stored on remote databases in which the information is transmitted to the hosted software solution 116 via an appropriate wired or wireless connection.

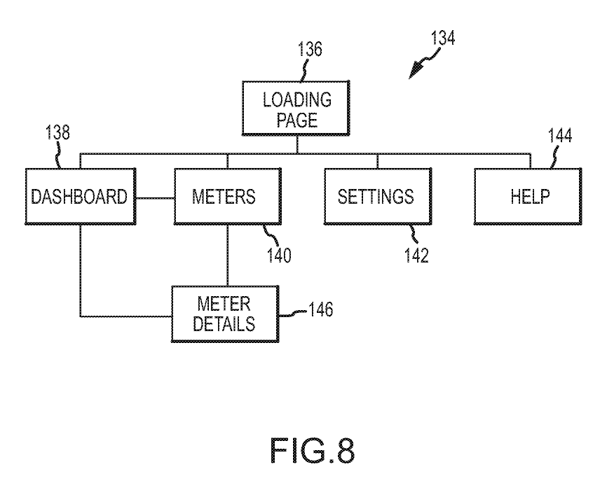

FIG. 8 illustrates a possible navigation map 134 for the user interface of the software control unit 114. The navigation map 134 may include a loading screen 136, a dashboard screen 138, a meters screen 140, a settings screen 142, a help screen 144, and a meter details screen 146. Further, the user has access to a “back” button that returns the user to any previously viewed screen except the loading screen 136. The user may also be provided with a menu that allows the user to navigate to any of the dashboard screen 138, the meters screen 140, the settings screen 142, and the help screen 144 from other screens. Additionally, from the dashboard screen 138, the user may navigate to the meters screen 140 or the meters detail screen 146 by selection of events displayed on the dashboard screen 138. Yet further, from the meters screen 140, the user may navigate to a meter details screen 146 that presents detailed information about the particular meter selected.

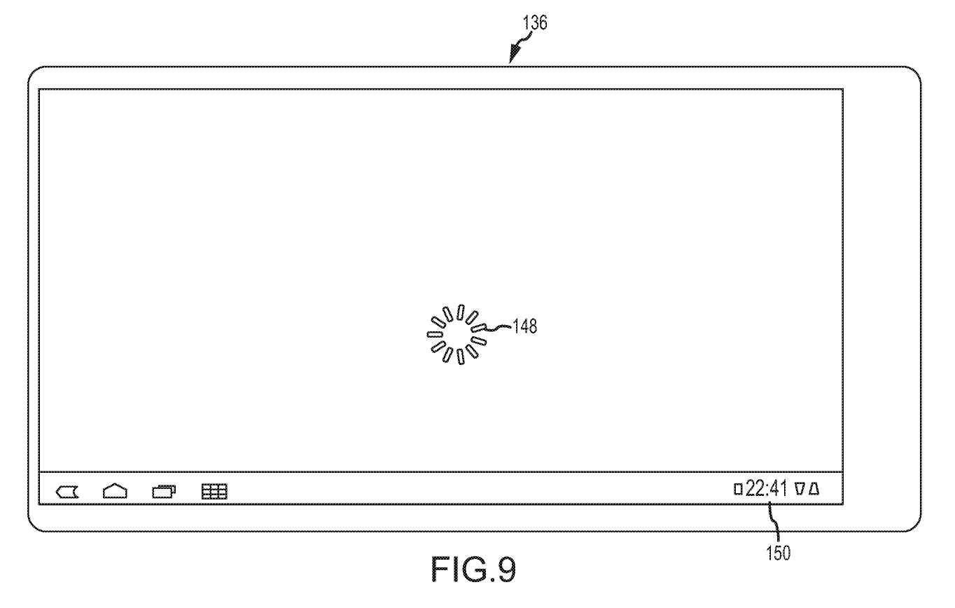

FIG. 9 illustrates a potential loading screen 136. The loading screen 136 may be presented to the user when the user launches the software application. The loading screen 136 may be visually presented to the user until the application has preloaded any configuration information and preset application settings. The loading screen 136 may include a loading icon 148. The loading screen 136 may further include a name of the application or other visual feature that identifies the application. If desired, a clock 150 may also be displayed on the loading screen 136.

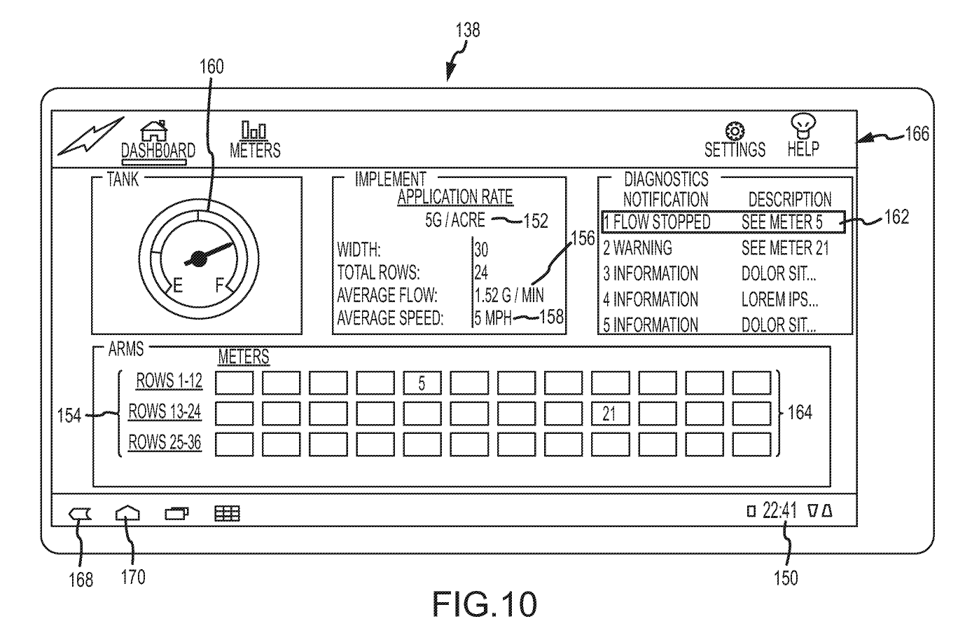

FIG. 10 illustrates a potential dashboard screen 138. After the application loads, the loading screen 136 may be replaced by the dashboard screen 138. A purpose of the dashboard screen 138 is to present the user with a visual summary of activity related to monitoring of the pressure or flow sensors or meters. Accordingly, the dashboard screen 138 may display information about current implementation information, such as the current desired fertilizer or other liquid application rate 152, the number of rows 154 being fertilized or treated, the average flow rate 156 of the fertilizer or other liquid, and the average speed 158 of the tractor or other farm equipment. The dashboard screen 138 may also display a fuel tank gauge 160 that shows an estimate of the amount of liquid remaining in the liquid supply source. The dashboard screen 138 may further display a predetermined number of alerts or other notices 162 raised by the application.

The dashboard screen 138 may also display a global “heat map” 164 of the sensor or meters and the status of the sensors or meters. The heat map 164 may be designed to provide visual information to the user so that a glance the user can assess whether there are any issues that need to be resolved. For example, each sensor or meter may be represented by a square or other symbol that is colored a particular color (e.g., green, yellow, or red) to inform a user whether or not the sensor or meter is operating within specified particulars. For example, when the square representing a sensor or meter is green, this color may inform the user that a sensor or meter is measure a flow rate or other measured information that is within predetermined parameters. Similarly, if the square representing a sensor or meter is red, this color may inform the user that the sensor or meter is indicating the flow rate or other measured information is not within the predetermined parameters, and thus may required attention. The display may also be configured to display the number of the sensor or meter within the square to indicate which sensor or meter is showing an issue. For example, assume there is an issue with the flow rate through sensor or meter 5 and a potential issue with the flow rate through sensor or meter 21. In this scenario, the numbers “5” and “21” may be displayed in their respective squares or other objects so the user may readily identify which sensor or meter is indicating that there is an issue with the flow through the sensor or meter.

A menu 166 may be positioned at the top of the dashboard screen 138 or at any desired location on the dashboard screen 138. The menu 166 may allow the user to directly navigate to the meters, the settings, or the help screens 140, 142, 144. Further, the user may navigate to the meters screen 140 by selecting one of the row labels. Yet further, the user may navigate to the meter details screen 146 for a particular sensor or meter by selecting the square or other object that represents the sensor or meter.

At the bottom of the dashboard screen 138 or at any suitable location, a back button icon 168, a clock 150, and any other desired information or icons may displayed. The back button icon 168 allows a user to return to any immediately previously displayed screen except the loading screen 136. The clock 150 may provide a visual representation of the current time. Other icons may include a home icon 170 that allows the user to return to a predetermined home screen.

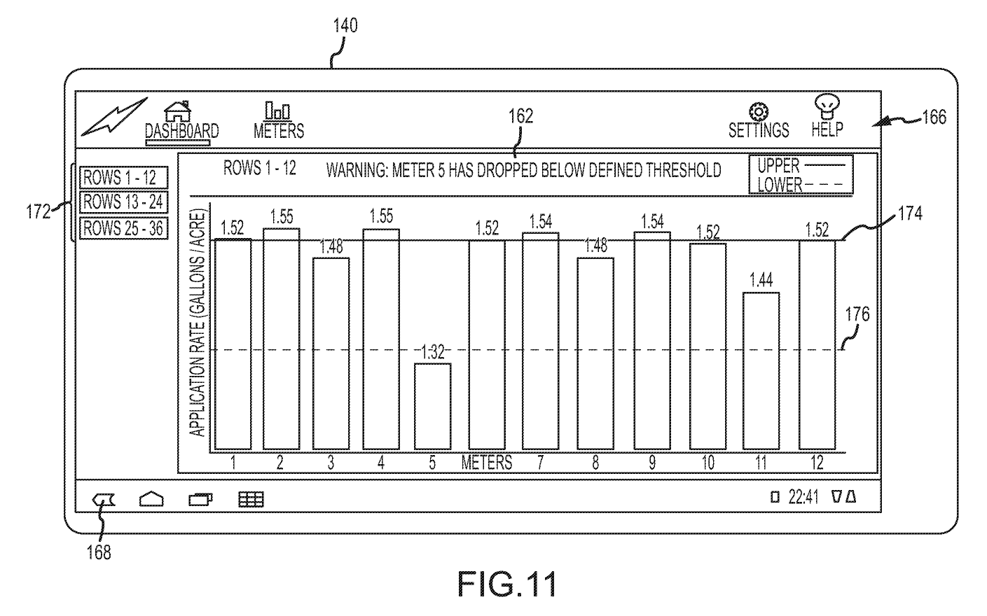

FIG. 11 illustrates a potential meters screen 140. The meters screen 140 may display the flow rates for a predetermined number of sensors or meters. With reference to FIG. 11, the current flow rates measured by sensors or meters 1-12 are shown. To select another group of sensors or meters to display, tabs 172 may be provided to indicate the various groups of sensors or meters that are available to be displayed. Selecting one of these tabs 172 results in that group of sensors or meters being displayed. In addition to showing the current flow rates measured by the selected group of sensors or meters, lines that represent upper and lower flow rate thresholds 174, 176 may be displayed to provide a visual indication of whether a particular flow rate as measured by the sensor or meter is within the upper and lower flow rate thresholds 174, 176. An alert or warning 162 for any of the sensors or meters may also be displayed on the meters screen 140.

Similar to the dashboard screen 138, the menu 166 may be displayed at the top of the meters screen 140, or at any desired location, to allow a user to navigate to the other primary screens. Also, the back button icon 168 and other icons or information may be displayed at the bottom of the meters screen 146, or at any other desired location. Finally, a user may navigate to the meter details screen 146 for a particular meter by selecting the graphical bar associated with the desired meter.

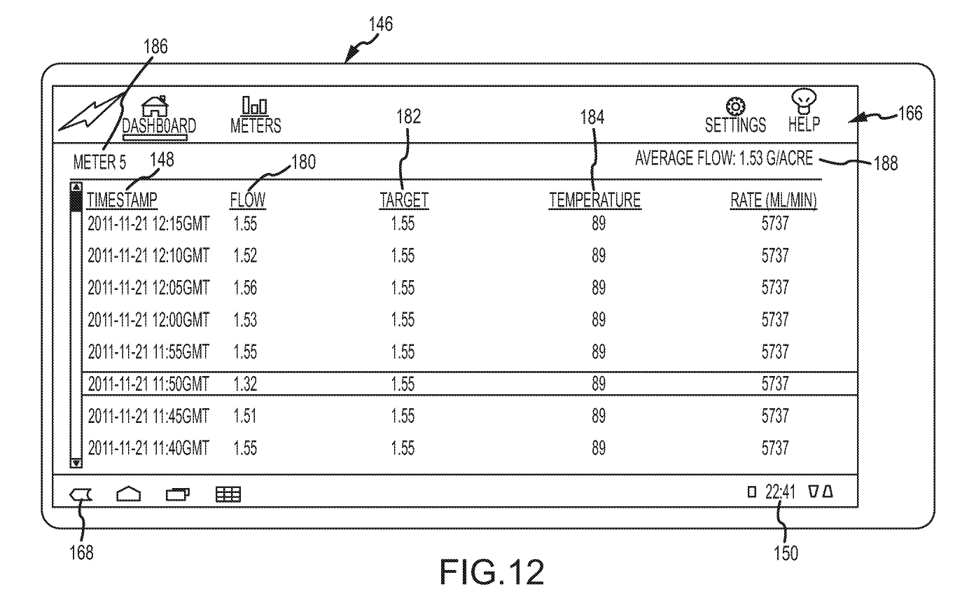

FIG. 12 illustrates a potential meter details screen 146. The meter details screen 146 may provide the user with detailed information about a particular sensor or meter. The provided information may include time that a measurement occurred 178, flow rate 180, target flow rate 182, temperature 184, and any other desired information. The information may be organized to display the flow rate 180, the target flow rate 182, and the temperature 184 at a specific time. The meter details screen 146 may also be configured to display an identification 186 of the sensor or meter being displayed and the average flow rate 188 as measured by the sensor or meter over a specified time period. Also, like the dashboard screen 138 and the meters screen 140, the meter details screen 146 may include the menu 166, the back icon button 168, the clock 150, and other icons or information.

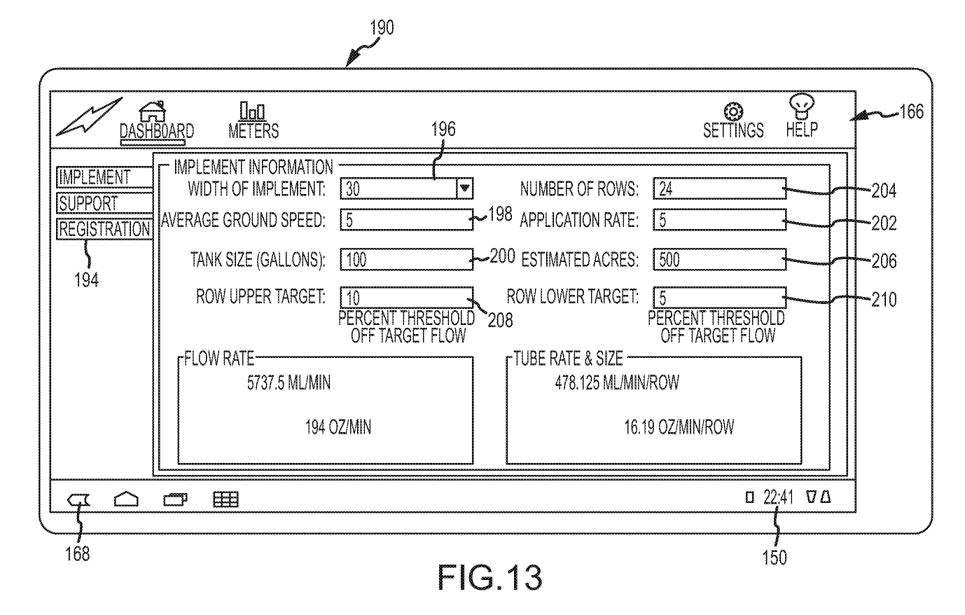

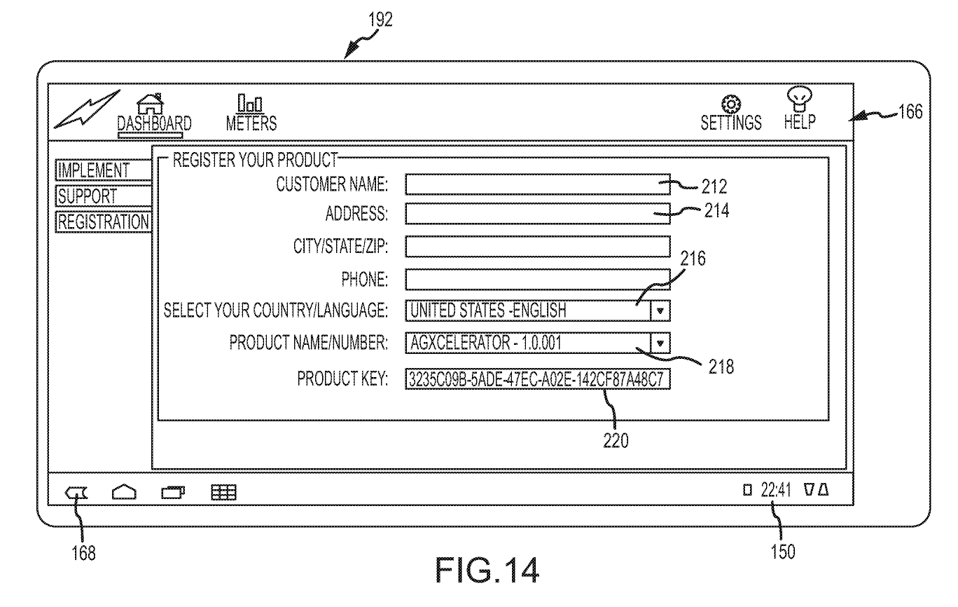

FIGS. 13 and 14 illustrate potential settings screens. In particular, the setting screens may include at least an implementation screen 190 and a registration screen 192. The implementation screen 190 may be initially displayed when the settings screen 142 is selected. The registration screen 192 may be accessed via a tab 194 on the implementation screen 190. With reference to FIG. 13, the implementation screen 190 may provide a display that allows a user to input predetermined information for a fertilizer or other liquid application. The information may include the width 196 of the fertilizer bar, the average speed 198 of that tractor or other farm equipment, the size 200 of the liquid supply source, the desired flow rate 202 of the liquid, the number of rows 204 to which liquid is delivered by the fertilizer bar, the estimated acres 206 to be treated with the liquid, and a percentage difference for the upper and lower threshold targets 208, 210 for the flow rate. With reference to FIG. 14, the registration screen 192 may include fields for the user to input or select user information, such as name 212 and address 214 of the user, the language 216 for displaying information, the product name 218, and the product key 220. Further, like the other screens, the implementation and registration screens 190, 192 may include the menu 166, the back button icon 168, the clock 150, and other icons.

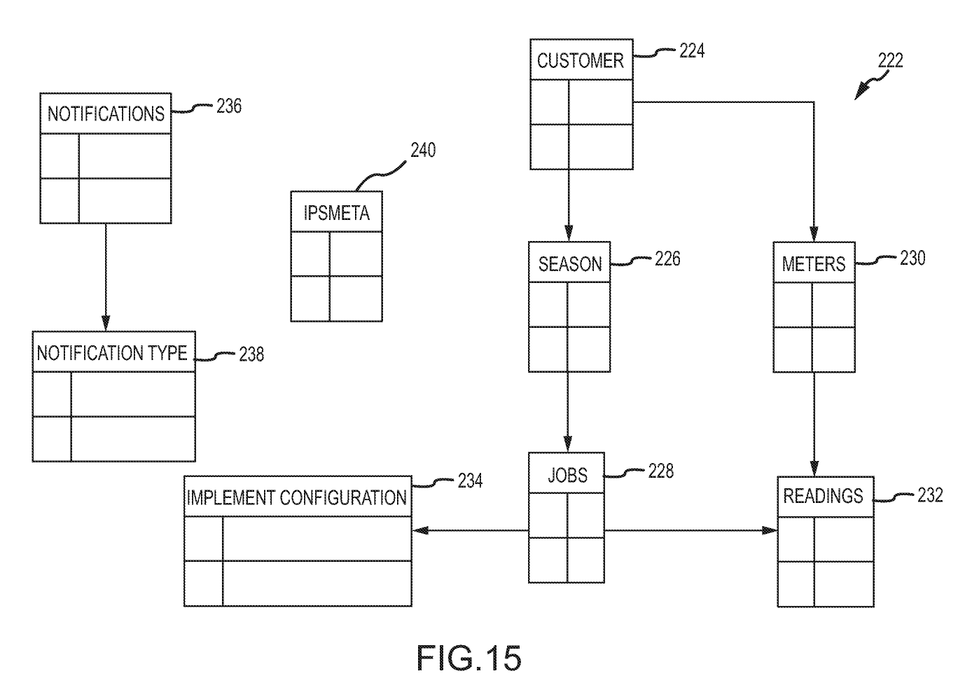

FIG. 15 illustrates a potential database configuration for the software control module 114. The database 222 may be configured to record and track key meter and configuration information. For example, the database 222 may include a customer table 224 that stores customer information, such as personal information about the user or users, the product key, and the name of the software product. The database 222 may also include a season table 226 that allows for various timestamps within a certain date range to be grouped together. Such a grouping may allow for year-to-year comparisons of recorded data. The database 222 may also include a jobs table 228 that may be configured to keep track of specific applications of liquid to a field in order to compare the effectiveness of one treatment application to a different treatment application. For example, if a user elected to change the application rate of fertilizer from 5 gallons/acre to 6 gallons/acre, a new job may be identified in the jobs table 228 to allow the effectiveness of the 5 gallon/acre treatment to the 6 gallon/acre treatment to be compared.

Another database table may be a meters table 230 that may be configured to track information about each sensor or meter. Yet another database table may be a readings table 232 that stores information about sensor or meter activity. The readings table 232 may be cross-referenced to the jobs and meters tables 228, 230. Still yet another database table may be an implementation table 234 that records implementation information entered in the settings screen. The implementation table 234 may be cross-referenced to the jobs table 228. There may also be notifications and notification type tables 236, 238 to record notifications or alerts that occur during monitoring of the system. Finally, there may be a meta table 240 that stores information (e.g., viscosity) that may be used in various calculations that are performed by the system.

While particular tables are shown and described for the database 222, the database 222 may include different or other tables. Yet further, while various tables are shown or described as cross-referenced to specific tables, the tables may be set up differently or may be cross-referenced to additional or different tables. Still yet further, the tables may combined or split up in order to store different or additional information in a particular table.

All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

1. A liquid fertilizer apparatus comprising:
a fluid bar fluidly connected to a fertilizer source, the fluid bar capable of attachment to a farm machine and including a fluid passageway that is in fluid communication with a plurality of apertures;
a plurality of sensors, each sensor positioned between the fluid passageway and at least one aperture of the plurality of apertures and configured to measure a characteristic of a fluid as the fluid flows from the fluid passageway to the at least one aperture; and
a sensor monitor in communication with the plurality of sensors and configured to display for each sensor the characteristic of the fluid measured by the sensor.

2. The liquid fertilizer apparatus of claim 1, wherein the characteristic is a fluid flow rate.

3. The liquid fertilizer apparatus of claim 1, wherein the characteristic is a fluid pressure differential.

4. The liquid fertilizer apparatus of claim 1, further comprising a pump fluidly connected to the fluid passageway and the fertilizer source.

5. The liquid fertilizer apparatus of claim 4, further comprising a pump controller operatively associated with the pump and configured to allow a user to selectively variably adjust a pump rate of the pump.

6. The liquid fertilizer apparatus of claim 5, further comprising a battery in communication with the pump and the pump controller.

7. The liquid fertilizer apparatus of claim 4, further comprising a first filter in fluid communication with the pump and the fertilizer source and positioned between the fertilizer source and the pump.

8. The liquid fertilizer apparatus of claim 7, further comprising a second filter in fluid communication with the pump and the fertilizer source and positioned between the pump and the fluid passageway.

9. The liquid fertilizer apparatus of claim 4, wherein the pump comprises an electric pump.

10. The liquid fertilizer apparatus of claim 1, wherein the fluid bar comprises polyvinyl chloride.

11. The liquid fertilizer apparatus of claim 1, further comprising a pressure gauge in fluid communication with the fluid passageway.

12. The liquid fertilizer apparatus of claim 11, further comprising a pressure gauge display in communication with the pressure gauge, and the pressure gauge display indicates the pressure of the fertilizer transported within the fluid passageway.

13. The liquid fertilizer apparatus of claim 1, where the fluid bar further comprises a plurality of mounts and each aperture of the plurality of apertures is located in a front surface of at least one of the plurality of mounts.

14. The liquid fertilizer apparatus of claim 1, further comprising a hose operatively connected to of the fluid bar and in fluid communication with at least one of the plurality of apertures.

15. The liquid fertilizer apparatus of claim 14, further comprising a seed cover assembly operatively connected to the hose.

16. The liquid fertilizer apparatus of claim 1, wherein the fertilizer source comprises a tank.

17. The liquid fertilizer apparatus of claim 1, wherein the farm machine comprises a tractor.

18. The liquid fertilizer apparatus of claim 17, wherein the tractor further comprises a cab, and the cab contains the sensor monitor.

19. The liquid fertilizer apparatus of claim 1, further comprising a planting device configured to be attached to the farm machine, and the planting device creates at least one furrow and deposits a seed in the furrow.

20. The liquid fertilizer apparatus of claim 19, further comprising at least one hose operatively attached to the at fluid bar, each of the at least one hose in fluid communication with the fluid passageway, and there is at least one hose for each at least one furrow created by the planting device.

21. A system as in claim 20, wherein the plurality of sensors are sufficiently numerous that there is at least one sensor for each furrow created by the planting device.

22. A method for fertilizing, comprising:
creating at least one furrow;
depositing a seed within the at least one furrow;
delivering fertilizer from a tank to a plurality of hoses;
distributing fertilizer from each of the plurality of hoses to an associated furrow;
monitoring a flow rate of the fertilizer in each of the plurality of hoses using a plurality of sensors where each hose in monitored by at least one of the plurality of sensors; and
displaying the fertilizer flow rate on a monitor for each of the plurality of hoses.

23. The method of fertilizing as in claim 22, wherein the monitor is located in a cab of a tractor.

24. A liquid flow metering system, comprising:
a reservoir configured to store a liquid;
a pump in fluid communication with the fertilizer reservoir and a plurality of fluid outlets, the plurality of fluid outlets configured to deliver to a desired area liquid received from the reservoir via the pump;
a plurality of sensors configured to monitor a flow rate of the liquid to each of the plurality of fluid outlets;
each of the plurality of sensors operatively associated with a hardware control; and
the hardware control operatively associated with a software control unit.

25. The liquid flow metering system of claim 24, wherein the software control unit is configured to display the flow rate of the liquid on a user interface.

26. The liquid flow metering system of claim 25, wherein the software control unit is further configured to display information about each of the plurality of sensors.

27. The liquid flow metering system of claim 25, the software control unit further configured to display an alert when one of the plurality of sensors measures a flow rate of the liquid to one of the plurality of fluid outlets that is outside of predetermined flow rate parameters.

28. The liquid flow metering system of claim 27, wherein the software control unit is further configured to allow a user to input the predetermined flow rate parameters via the user interface.

29. The liquid flow metering system of claim 25, wherein the software control unit is further configured to change a visual object that represents one sensor of the plurality of sensors from a first state to a second state when the one sensor measures a flow rate of the liquid to one of the plurality of fluid outlets that is outside of predetermined flow rate parameters.

30. The liquid flow metering system of claim 29, wherein the first state involves the object being displayed as green in color and the second state involves the object being displayed as red in color.

31. The liquid flow metering system of claim 30, wherein the second state further involves an identification number for the one sensor being displayed.

32. The liquid flow metering system of claim 24, further comprising at least one second sensor operatively associated with the hardware control.

33. The liquid flow metering system of claim 32, wherein the at least one second sensor is selected from a group consisting of a seed sensor, a soil pH sensor, a yield sensor, a global positioning system sensor, and a moisture sensor.

34. The liquid flow metering system of claim 24, wherein the liquid comprises a fertilizer.

35. The liquid flow metering system of claim 24, wherein the desired area comprises an agricultural field.
